(19) United States
(12) Patent Application Publication
(10) Pub. No.: US 2026/0080845 A1
(43) Pub. Date: Mar. 19, 2026

(54) DISPLAY DEVICE

(71) Applicant: Japan Display Inc., Tokyo (JP)

(72) Inventors: Takuo KAITOH, Tokyo (JP); Akihiro HANADA, Tokyo (JP); Motochika YUKAWA, Tokyo (JP)

(21) Appl. No.: 19/323,261

(22) Filed: Sep. 9, 2025

(30) Foreign Application Priority Data
Sep. 17, 2024 (JP) 2024-159893

(51) Int. Cl. G09G 3/36; G02F 1/1362; G02F 1/1368

(52) U.S. Cl. CPC G09G 3/3677; G02F 1/136286; G02F 1/1368; G09G 2300/0426

(57) ABSTRACT

A display device includes a display panel having a liquid crystal layer arranged between a pair of substrates, a light source that makes light incident into the liquid crystal layer from one side surface of the display panel, the display panel includes a display area in which a plurality of pixels is arranged, a non-display area adjacent to the display area and in which a plurality of dummy pixels is arranged, a peripheral area arranged along a periphery of the display panel other than the one side surface and surrounding the non-display area, a driving circuit arranged in the peripheral area, a plurality of first wirings connected to the driving circuit and extending in a first direction, and a plurality of second wirings extending in a second direction intersecting the first direction.

### CROSS-REFERENCE TO RELATED APPLICATIONS

This application is based upon and claims the benefit of priority from the prior Japanese Patent Application No. 2024-159893 filed on Sep. 17, 2024, the entire contents of which are incorporated herein by reference.

### FIELD

An embodiment of the present invention relates to a display device.

### BACKGROUND

As a liquid crystal display device, there are transmissive displays that display images by transmitting light from a backlight arranged behind the liquid crystal panel, a reflective display that displays an image by reflecting external light with pixel electrodes, and a semi-transmissive display that combines the characteristics of both transmissive and reflective displays. These liquid crystal display devices are used as displays for electronic devices such as personal computers and smartphones, and are designed so that the background cannot be seen through the screen.

In contrast, a display device has been developed that allows the background to be seen through while displaying images. For example, a display device has been disclosed in which the display area is composed of a polymer-dispersed liquid crystal arranged between a pair of translucent substrates so that the background can be seen through (see Japanese laid-open patent publication No. 2021-092748 and Japanese laid-open patent publication No. 2021-092702).

### SUMMARY

A display device according to an embodiment of the present invention includes a display panel having a liquid crystal layer arranged between a pair of substrates, and a light source that makes light incident into the liquid crystal layer from one side surface of the display panel, wherein the display panel includes a display area in which a plurality of pixels is arranged, a non-display area adjacent to the display area and in which a plurality of dummy pixels is arranged, a peripheral area arranged along a periphery of the display panel other than the one side surface and surrounding the non-display area, a driving circuit arranged in the peripheral area, a plurality of first wirings connected to the driving circuit and extending in a first direction, and a plurality of second wirings extending in a second direction intersecting the first direction. The plurality of pixels and the plurality of dummy pixels are the same size and arranged at the same pitch, the display area and the non-display area are translucent, and an image displayed in the display area is visible from the first surface side of the display panel and the second surface side opposite the first surface.

### BRIEF DESCRIPTION OF DRAWINGS

FIG. 1 is a perspective view illustrating an overview of a display device according to an embodiment of the present invention.

FIG. 2 is a schematic cross-sectional view showing a configuration corresponding to a region between A1-A2 of the display device shown in FIG. 1.

FIG. 3 is a plan view showing a configuration of a display device according to an embodiment of the present invention.

FIG. 4 is a block diagram showing a pixel in a display device according to an embodiment of the present invention.

FIG. 5 is a plan view of a pixel and a dummy pixel in a display device according to an embodiment of the present invention.

FIG. 6 is a plan view of a pixel in a display device according to an embodiment of the present invention.

FIG. 7 is a cross-sectional view of a pixel in a display device according to an embodiment of the present invention.

FIG. 8 is a plan view of a dummy pixel in a display device according to an embodiment of the present invention.

FIG. 9 is a cross-sectional view of a dummy pixel in a display device according to an embodiment of the present invention.

FIG. 10 is a plan view of a display device according to an embodiment of the present invention.

### DESCRIPTION OF EMBODIMENTS

Hereinafter, embodiments of the present invention will be described with reference to the drawings and the like. However, the present invention can be mounted in various aspects without departing from the gist thereof, and is not to be construed as being limited to the description of the embodiments exemplified below. Further, with respect to the drawings, although the width, the thickness, the shape, and the like of each part may be schematically represented in comparison with the actual embodiment in order to clarify the description, the schematic drawings are merely examples, and do not limit the interpretation of the present invention. Further, in the present specification and the drawings, the same or similar elements as those described with respect to the drawings described above are denoted by the same symbols, and redundant description may be omitted. In this specification and the like, ordinal numbers are given for convenience in order to distinguish components, parts, and the like, and do not indicate priority or order.

In the present invention, in the case where a single film is processed to form a plurality of films, the plurality of films may have different functions and roles. However, the plurality of films is derived from films formed as the same layer in the same process, and has the same layer structure and the same material. Therefore, the plurality of films is defined as being present in the same layer. In addition, in the case where a plurality of films is formed by processing a certain film, in the present specification and the like, the films may be described separately as −1, −2, and the like.

In addition, in this specification and the like, expressions such as “upper” and “lower” represent relative positional relationships between a structure of interest and other structures. In the present specification and the like, in a side view, a direction from an array substrate to a pixel electrode, which will be described later, is defined as “upper”, and a reverse direction thereof is defined as “lower”. In this specification and claims, the expression “on” in describing the manner of arranging another structure on a certain structure shall include both arranging another structure directly above a certain structure and arranging another structure over a certain structure via yet another structure, unless otherwise specified.

### First Embodiment

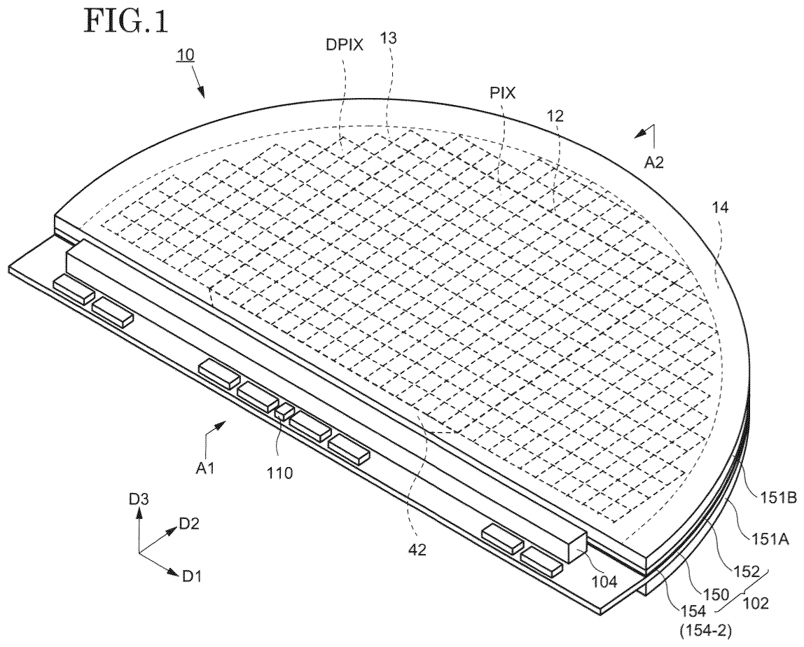

A display device 10 according to an embodiment of the present invention will be described with reference to FIG. 1 to FIG. 10.

[Overview of Display Device]FIG. 1 is a perspective view of the display device 10 according to an embodiment of the present invention. The display device 10 includes a display panel 102 including a pair of an array substrate 150 and a counter substrate 152, a liquid crystal layer between the array substrate 150 and the counter substrate 152 (not shown), and a driving circuit (not shown), a light source 104, and a first transparent substrate 151A and a second transparent substrate 151B sandwiching the display panel 102. In the following explanation referring to FIG. 1, one direction of the plane of the display panel 102 is a direction D1, a direction orthogonal to the direction D1 is a direction D2, and a direction orthogonal to the D1-D2 plane is a direction D3.

The array substrate 150 and the counter substrate 152 have light-transmitting properties. The array substrate 150 and the counter substrate 152 are preferably transparent to visible light. The counter substrate 152 is arranged facing the array substrate 150 in the direction D3. The array substrate 150 and the counter substrate 152 are bonded to each other by a sealing material 154 in a state of being arranged facing each other with a gap therebetween. The liquid crystal layer (not shown) is arranged in a gap between the array substrate 150 and the counter substrate 152.

The display panel 102 has a display area 12, a non-display area 13 adjacent to the display area 12, and a peripheral area 14 surrounding the non-display area 13 and outside the display area 12. In the display area 12, a plurality of pixels PIX is arranged in a row direction and a column direction. Here, the row direction refers to a direction parallel to the direction D1, and the column direction refers to a direction parallel to the direction D2. In the display area 12, m pixels are arranged in the row direction, and n pixels are arranged in the column direction. The values of m and n are appropriately set according to a display resolution in the vertical direction and a display resolution in the horizontal direction. In the display area 12, a scan signal line (also referred to as a gate wiring) is arranged in the direction D1, and a video signal line (also referred to as a source wiring) is arranged in the direction D2.

The display panel 102 may have a shape different from that of the display area 12. As shown in FIG. 1, the display panel 102 may have a shape different from the rectangular shape of the display area 12 and may have a continuously curved portion at the outer peripheral edge 1020. FIG. 1 shows an example in which the outer peripheral edge 1020 of the display panel 102 is semicircular, but this shape is not limited to this.

The driving circuit is arranged in the peripheral area 14 of the array substrate 150. The driving circuit includes a scanning signal line driving circuit that outputs scanning signals to pixels PIX and a video signal line driving circuit that outputs video signals. Details of the driving circuit will be described later, but FIG. 1 shows an example in which the driving circuit is formed by a thin film transistor (TFT) on the array substrate 150 in the peripheral area 14. In the peripheral area 14, the scanning signal line driving circuit is arranged at the end of the scanning signal line in both the display area and the non-display area, and the video signal line driving circuit can be arranged at the end of the video signal line. The driving circuit is not limited to the configuration shown in the drawings, and may be provided as an integrated circuit (IC) and mounted by a COG (Chip on Glass) method to the array substrate 150 or mounted by a COF (Chip on Film) method.

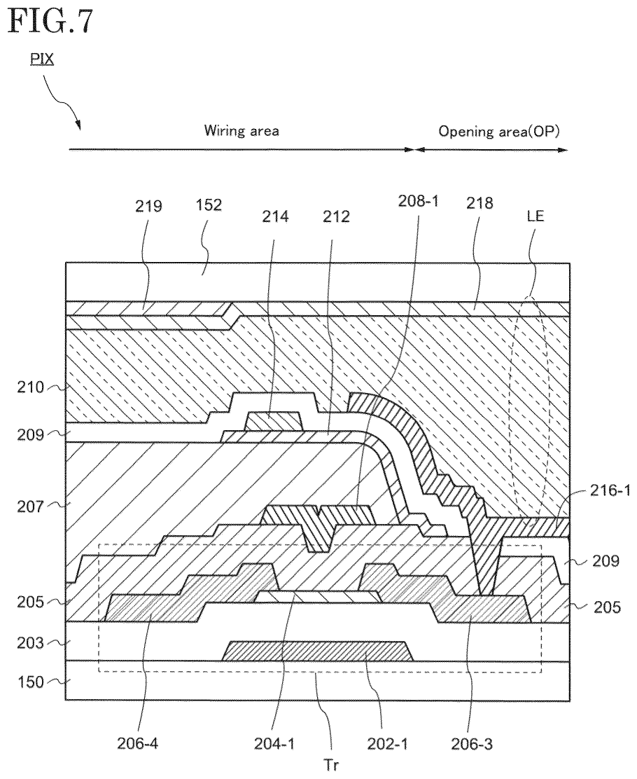

A scanning signal line area, a common wiring area, and a video signal line area may be arranged in the peripheral area 14. The video signal line area is an area in which a pattern formed by a wiring connecting the scanning line driving circuit 28 and a scanning line GL arranged in the display area 12 is arranged. The common wiring area is an area in which a pattern formed by a common wiring is arranged. The common wiring area is used as a wiring for applying a common voltage to a common electrode 218 (see FIG. 7) arranged circuit-wise on the counter substrate 152. The video signal line area is an area in which a pattern formed by a wiring connecting the video signal line driving circuit and a video signal line wiring SL arranged in the display area 12 is arranged.

The light source 104 has a structure along the direction D1. For example, the light source 104 includes a light emitting diode (LED) arranged along the direction D1. A detailed configuration of the light source 104 is not limited, and may include optical members such as a reflector, a diffuser, and a lens in addition to the light emitting diodes arranged in the direction D1. The light source 104 and a light emission control circuit 110 for controlling the light source 104 may be arranged as separate members independent of the display panel 102, and light emission timing of the light source 104 may be controlled by the light emission control circuit 110 synchronized with the scanning line driving circuit and the video signal line driving circuit. The light emission control circuit 110 for controlling the light source 104 may be arranged as a separate member as well as the light source 104 separately from the display panel 102, may be mounted on the array substrate 150 as an individual component, or may be incorporated in the scanning line driving circuit or the video signal line driving circuit. The light source 104 is arranged and controlled as described above, and can irradiate light onto the liquid crystal layer 210 from one side surface 15C of the display panel 102. Note that one side surface of the display panel 102 is the surface onto which light from the light source 104 is irradiated.

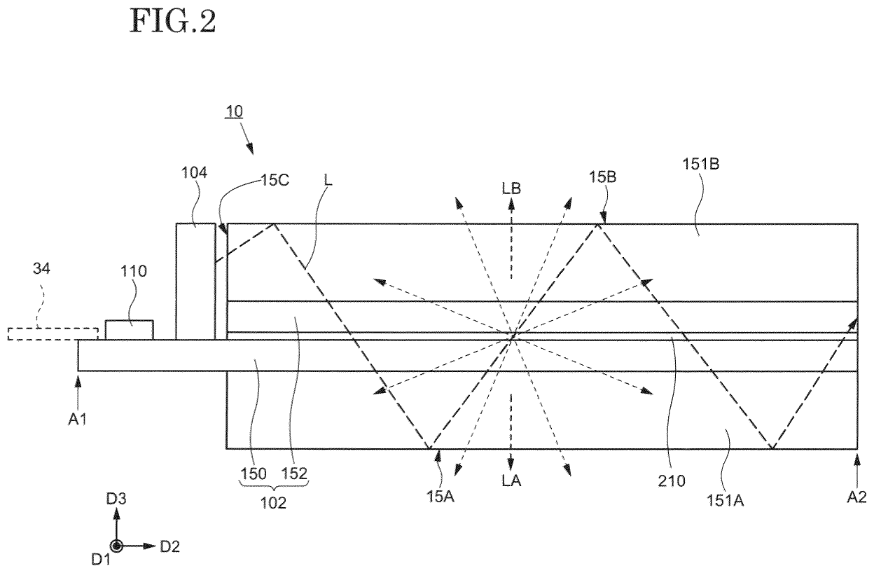

The first transparent substrate 151A and the second transparent substrate 151B are formed to match the shape of the display panel 102. The outer peripheral edges of the first transparent substrate 151A and the second transparent substrate 151B are formed so as to coincide or substantially coincide with the outer peripheral edges of the display panel 102, and the shape of the display device 10 corresponds to the shapes of the first transparent substrate 151A, the second transparent substrate 151B, and the display panel 102. The first transparent substrate 151A and the second transparent substrate 151B are arranged so as to sandwich the display area 12, the non-display area 13 and the peripheral area 14. The first transparent substrate 151A and the second transparent substrate 151B function as protective members of the display panel 102. Further, as described with reference to FIG. 2, the first transparent substrate 151A and the second transparent substrate 151B function as light guide plates for introducing the light incident from the light source 104 into the display panel 102.

FIG. 2 shows a cross-sectional configuration of the display device 10 corresponding to A1-A2 shown in FIG. 1. As shown in FIG. 2, the first transparent substrate 151A is arranged on a side of the array substrate 150 of the display panel 102, and the second transparent substrate 151B is arranged on a side of the counter substrate 152. A glass substrate or a plastic substrate is used as the first transparent substrate 151A and the second transparent substrate 151B. The first transparent substrate 151A and the second transparent substrate 151B preferably have refractive indexes equivalent to those of the array substrate 150 and the counter substrate 152. The array substrate 150 and the first transparent substrate 151A, and the counter substrate 152 and the second transparent substrate 151B are bonded to each other with a transparent adhesive (not shown).

In the display panel 102, the array substrate 150 and the counter substrate 152 are arranged facing each other, and a liquid crystal layer 210 is arranged therebetween. The array substrate 150 is larger than the counter substrate 152, and has a size such that part of the peripheral area 14 is exposed from the counter substrate 152. A driving circuit (light emission control circuit 110 in FIG. 2) is mounted on the array substrate 150. A flexible printed circuit 34 is attached to a peripheral portion of the array substrate 150.

The light source 104 is arranged to be adjacent to one side surface of the first transparent substrate 151A or the second transparent substrate 151B. FIG. 2 shows a configuration in which the light source 104 is arranged along one side surface of the second transparent substrate 151B. Further, although FIG. 2 shows a configuration in which the light source 104 is attached to the array substrate 150, the configuration is not limited to the configuration in which the light source 104 is arranged, and the mounting structure is not limited as long as a mounting position can be fixed. For example, the light source 104 may be supported by a housing surrounding the display panel 102.

As shown in FIG. 2, the light source 104 is arranged along a first side surface 15C of the second transparent substrate 151B. As shown in FIG. 2, the light source 104 irradiates the first side surface 15C (the one side surface 15C of the display panel 102) of the second transparent substrate 151B with a light L. The light source 104 may be referred to as a side light source because it emits the light L toward the first side surface 15C. The first side surface 15C of the second transparent substrate 151B facing the light source 104 serves as a light incidence surface.

As schematically shown in FIG. 2, the light L incident from the first side surface 15C of the second transparent substrate 151B propagates in a direction away from the first side surface 15C (the direction D2) while being reflected by a second plane 15B of the second transparent substrate 151B and a first plane 15A of the first transparent substrate 151A. When the light L is directed to the outside from the first plane 15A of the first transparent substrate 151A and the second plane 15B of the second transparent substrate 151B, the light L proceeds from a medium having a large refractive index to a medium having a small refractive index. In this case, when an incident angle of the light L incident on the first plane 15A and the second plane 15B is larger than a critical angle, the light L is totally reflected, and is guided to the direction D2 while being reflected by the first plane 15A and the second plane 15B.

The liquid crystal layer 210 is formed of a polymer-dispersed liquid crystal. In the liquid crystal layer 210 formed of the polymer-dispersed liquid crystal, a scattering state and a non-scattering state are controlled for the pixel PIX (see FIG. 1). Since dummy pixels DPIX do not display images, the state of the liquid crystal layer 210 in the dummy pixels DPIX is not controlled. As shown in FIG. 2, in the light L propagating while being reflected by the first plane 15A and the second plane 15B, if there is a pixel in which the liquid crystal layer 210 is in the scattering state, at least a part of the light is scattered, an incident angle of the scattered light becomes an angle smaller than the critical angle, scattered lights LA and LB are respectively emitted to the outside from the first plane 15A and the second plane 15B, and the emitted scattered lights LA and LB are observed by an observer. In the display panel 102, an area other than an area where the scattered lights LA and LB are emitted is substantially transparent because the array substrate 150, the counter substrate 152, the first transparent substrate 151A, and the second transparent substrate 151B are translucent (transparent to visible light), and the liquid crystal layer 210 is in the non-scattering state, and the observer can see the image displayed in the display area 12 from the front side of the display panel 102 and from the back side opposite the front side of the display panel 102.

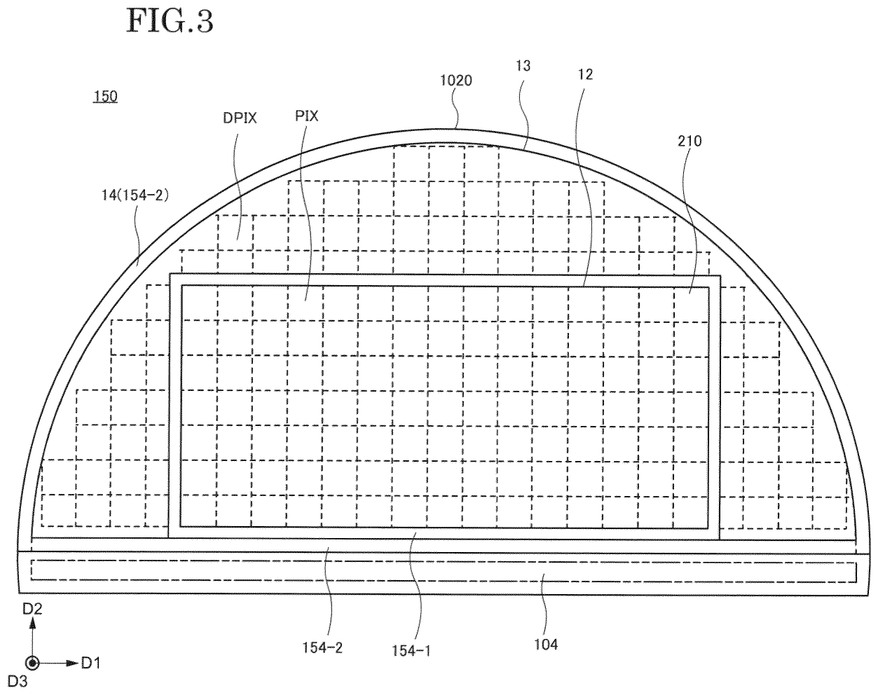

FIG. 3 is a plan view illustrating a configuration of the array substrate 150 of the display device 10 according to the embodiment of the present invention. As shown in FIG. 3, the array substrate 150 includes the display area 12, the non-display area 13 and the peripheral area 14.

The display area 12 is arranged at the center or inside of the array substrate 150. The display area 12 may be arranged in an area surrounded by the sealing material 154-1. The sealing material 154-1 is provided between the array substrate 150 and the counter substrate 152. The display area 12 includes the plurality of pixels PIX arranged in a matrix. Each of the plurality of pixels PIX has a plurality of transistors and liquid crystal elements. Each of the plurality of transistors is electrically connected to the scanning signal line GL extending in the column direction (D2 direction) and the video signal line SL extending in the column direction (D1 direction) intersecting the row direction.

The non-display area 13 is provided adjacent to the display area 12. The non-display area 13 is provided between the display area 12 and the peripheral area 14. When the display area 12 and the peripheral area 14 are adjacent, it is not necessary to provide a non-display area 13 between the display area 12 and the peripheral area 14. The non-display area 13 may be provided so as to surround at least a part of the display area 12. For example, in FIG. 3, the non-display area 13 is provided so as to surround the display area 12 except for one side. By setting the non-display area 13 to fill the area between the display area 12 and the peripheral area 14, it is possible to achieve consistency between the shape of the display panel 102 and the shape of the display area 12.

The non-display area 13 may be provided in the area overlapping the sealing material 154-1 and the area surrounding the overlapping area. As shown in FIG. 3, when the sealing material 154-1 is provided so as to surround the display area 12, the non-display area 13 is provided in the area surrounding the sealing material 154-1. In addition, the area overlapping the sealing material 154-1 on the array substrate 150 may be a non-display area 13.

The non-display area 13 may be provided in the area surrounded by the sealing material 154-2. In the array substrate 150, the area overlapping the sealing material 154-2 may be the area surrounding the peripheral area 14, or it may be the area overlapping the peripheral area 14. Here, the sealing material 154-2 corresponds to the sealing material 154 shown in FIG. 1, and the non-display area 13 and the display area 12 are provided in the area surrounded by the sealing material 154-2.

The non-display area 13 has a plurality of dummy pixels DPIX arranged in a matrix. The plurality of dummy pixels DPIX can be arranged in a plurality of columns extending from the display area 12 toward the peripheral area 14. When the distance between the display area 12 and the peripheral area 14 is short, a small number of dummy pixels DPIX are provided. When the distance between the display area 12 and the peripheral area 14 is long, a large number of dummy pixels DPIX are provided. For example, as shown in FIG. 3, when the shape of the display panel 102 is semicircular, the number of dummy pixels DPIX arranged in a plurality of columns extending from the display area 12 toward the peripheral area 14 increases toward the light source 104 or the chord of the semicircle.

A plurality of dummy pixels DPIX is the same size as a plurality of pixels PIX and are arranged at the same pitch. The plurality of dummy pixels DPIX and the plurality of pixels PIX being the same size means that the shape of the pixels and the area occupied by the pixels are the same. Furthermore, the plurality of pixels PIX and the plurality of dummy pixels DPIX are arranged at the same pitch. The plurality of pixels PIX and the plurality of dummy pixels DPIX are of the same size and are arranged at the same pitch, so that the display area 12 and the non-display area 13 can have the same degree of light transmittance. Incidentally, having the same degree of light transmittance in the display area 12 and the non-display area 13 means that the transmittance of the display area 12 and the transmittance of the non-display area 13 are made similar to each other. Alternatively, the display area 12 and the non-display area 13 have the same degree of light transmittance, which means that the observer has difficulty in recognizing the boundary between the display area 12 and the non-display area 13.

Each of the plurality of dummy pixels DPIX has a structure lacking at least one configuration of the transistor Tr of the pixel PIX. The dummy pixel DPIX has a structure in which no image is displayed, i.e., no voltage is applied to the liquid crystal layer 210. Details will be described later, but for example, the dummy pixel DPIX has a structure that lacks the semiconductor layer in the transistor configuration of the pixel PIX. Since the dummy pixel DPIX does not have a semiconductor layer, no image signal is output to the pixel electrode, and no image is displayed.

The peripheral area 14 is arranged along the periphery other than one side surface of the display panel 102. The one side surface of the display panel 102 is, for example, as shown in FIG. 2 or FIG. 3, the surface facing the light source 104 (the surface parallel to the first side surface 15C). The peripheral area 14 is arranged so as to surround the display area 12. The peripheral area 14 is provided so as to surround the non-display area 13. The peripheral area 14 may be provided so as to surround at least one side surface other than the display area 12 and the non-display area 13, as shown in FIG. 3. In addition, the peripheral area 14 refers to an area from the display area 12 or the non-display area 13 to an end portion of the array substrate 150 in the array substrate 150. In other words, the peripheral area 14 refers to an area other than an area where the display area 12 and the non-display area 13 is arranged on the array substrate 150 (that is, an area outside the display area 12 or the non-display area 13).

In the peripheral area 14, the driving circuit and wirings that electrically connect the driving circuit to the plurality of dummy pixels DPIX and the driving circuit to the plurality of pixels PIX are provided.

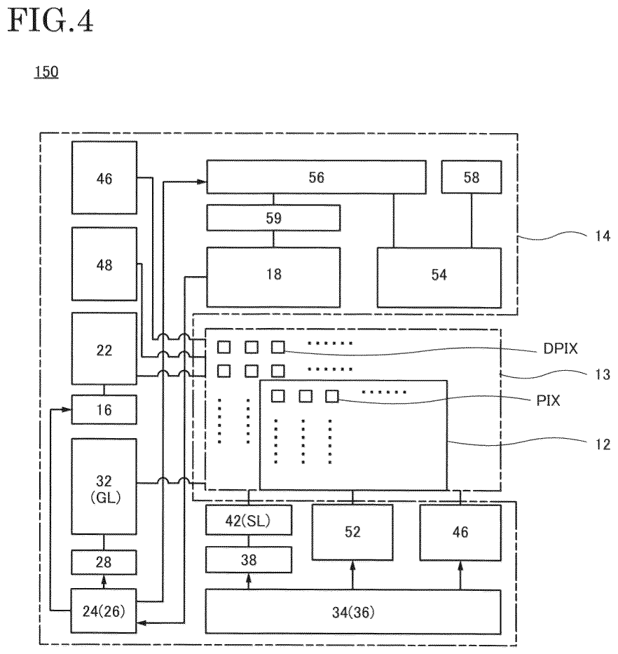

FIG. 4 is a block diagram showing the configuration of the array substrate 150 of the display device 10 according to an embodiment of the present invention. As shown in FIG. 4, the array substrate 150 includes the display area 12, the non-display area 13, and the peripheral area 14. The solid lines and arrow lines shown in FIG. 4 indicate direct or electrical connections.

In the peripheral area 14, in addition to the scanning line driving circuit 28 and the video signal line driving circuit 38, the scanning signal line area 32, the video signal line area 42, an ESD protection circuit 46, a gate inspection circuit 48, a source inspection circuit 52, common wirings 16 and 18, terminal parts 26 and 36, flexible printed circuits 24 and 34, and various inspection circuits may be arranged. The terminal parts 26 and 36 are arranged along one side of the array substrate 150.

The flexible printed circuit 24 is connected to the terminal part 26. The flexible printed circuit 24 supplies various signals to the scanning line driving circuit 28, the common wirings 16 and 18, an ESD protection circuit 59 (including a short ring SR), and a QD pad 56. The scanning line driving circuit 28 is connected to a plurality of scanning signal lines GL, and each of the plurality of scanning signal lines GL is electrically connected to each of the plurality of dummy pixels DPIX in the non-display area 13 and each of the plurality of pixels PIX in the display area 12. FIG. 4 represents the area where the plurality of scanning signal lines GL are arranged as the scanning signal line region 32. The number of scanning signal lines GL connected to two scanning line driving circuits 28 corresponds to the number of rows of the pixels PIX in the display area 12.

The flexible printed circuit 34 is connected to the terminal part 36. The flexible printed circuit 34 supplies a video signal to the video signal line driving circuit 38. The video signal line driving circuit 38 is connected to a plurality of video signal lines SL, and each of the plurality of video signal lines SL is electrically connected to each of the plurality of dummy pixels DPIX in the non-display area 13 and each of the plurality of pixels PIX in the display area 12. FIG. 4 is a representation of an area in which the plurality of video signal lines SL is arranged as the video signal line area 42. The number of video signal lines SL connected to the video signal line driving circuit 38 corresponds to at least three times the number of columns of the pixel PIX in the display area 12.

The inspection line 54 is connected to an ESD protection circuit 58 and the QD pad 56. Furthermore, the common wiring 18 is connected to the ESD protection circuit 59.

The common wiring 16 may be arranged so as to surround the peripheral area 14 of the array substrate 150, and signals are supplied from a flexible printed circuit 24. The common wiring 16 is electrically connected to the mesh-shaped common wiring area 22.

The display device 10 is not limited to a high-speed drive panel such as the transparent display shown in FIG. 1 and FIG. 2. The display device 10 can be applied to a large high-definition panel used in a display device that is not a transparent display.

### [Configuration of Pixel]

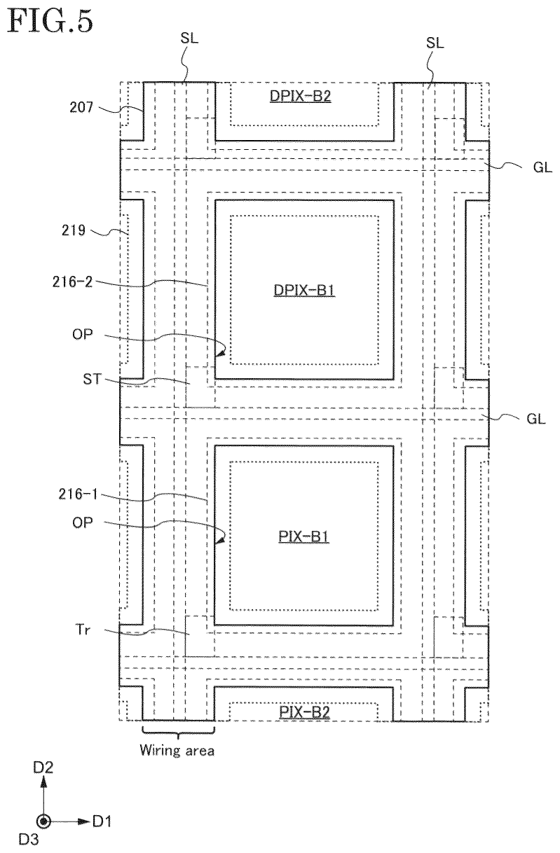

FIG. 5 is a diagram illustrating a configuration of the pixel PIX included in the display device 10 according to an embodiment of the present invention. The configuration of the pixel according to an embodiment of the present invention will be described in detail below.

FIG. 5 shows a pixel PIX-B1 and a dummy pixel DPIX-B1 arranged in the column direction (D2 direction) in the adjacently arranged display area 12 and non-display area 13. The pixel PIX-B1 and the dummy pixel DPIX-B1 are electrically connected to the video signal line SL and the scanning signal line GL, respectively.

The pixel PIX-B1 includes a transistor Tr and a holding capacitance (not shown) on the array substrate 150. A gate of the transistor Tr is connected to the scanning line GL, a source of the transistor Tr is connected to the video signal line SL, and a drain of the transistor Tr is connected to one electrode of the liquid crystal element and one electrode of the holding capacitance. The other electrode of the liquid crystal element is connected to the common wiring. The other electrode of the holding capacitance is connected to the capacitance wiring.

The transistor Tr has a function of controlling a time to write the video signal supplied from the source wiring to the pixel by switching between the on-state and the off-state. Turning on the transistor Tr makes it possible to write a potential corresponding to the video signal supplied from the source wiring to the holding capacitance electrically connected to the transistor Tr. In addition, turning off the transistor Tr makes it possible to hold the potential held in the holding capacitance.

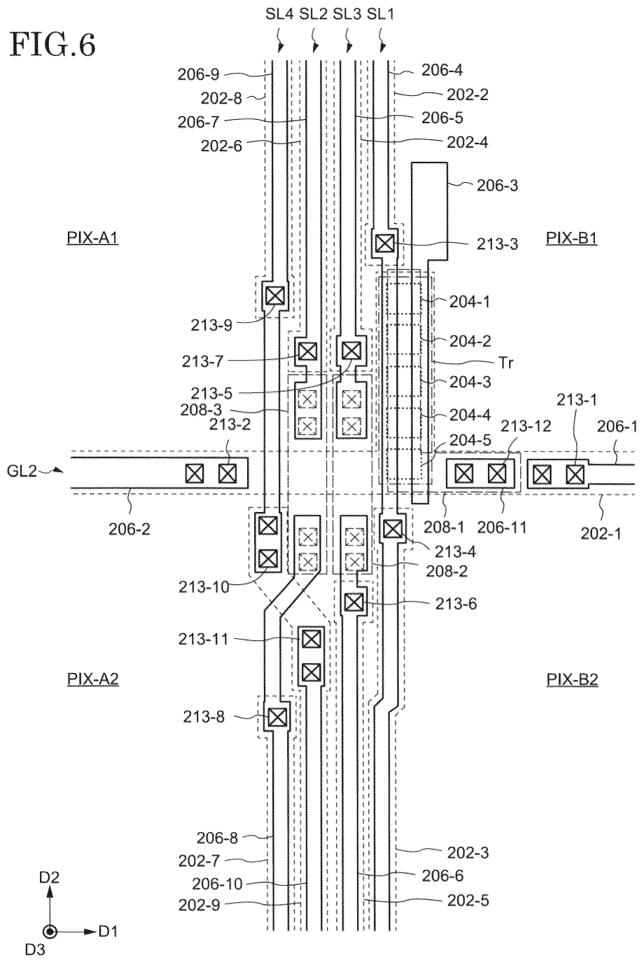

Next, the configuration of the transistor Tr will be described with reference to FIG. 6 and FIG. 7. FIG. 6 is a plan view illustrating the configuration of the transistor Tr of the pixel PIX included in the display device 10 according to an embodiment of the present invention. FIG. 7 is a cross-sectional view illustrating the configuration of the transistor Tr of the pixel PIX included in the display device 10 according to an embodiment of the present invention.

FIG. 6 is a plan view of the transistor Tr of the pixel PIX-B1 shown in FIG. 5 and its periphery. FIG. 6 shows a planar layout of the conductive layers 202-1 to 202-9, the oxide semiconductor layers 204-1 to 204-5, and conductive layers 206-1 to 206-11. The conductive layers 202-1 to 202-9 are arranged on the array substrate 150. The conductive layer 202-1 extends in the direction D1 but has an area branched in the direction D2. In addition, the conductive layers 202-2 to 202-9 extend in the direction D2. The oxide semiconductor layers 204-1 to 204-5 are arranged on the conductive layer 202-1 via the gate insulating film 203 (see FIG. 7). The oxide semiconductor layers 204-1 to 204-5 are arranged side by side in the direction D2. In the present embodiment, an example in which the transistor Tr is formed using five oxide semiconductor layers 204-1 to 204-5 will be shown. The number of oxide semiconductor layers is not particularly limited. The conductive layers 206-1 to 206-11 are arranged on the gate insulating film and the oxide semiconductor layers 204-1 to 204-5. The conductive layers 206-1, 206-2, and 206-11 extend in the direction D1 and the conductive layers 206-3 to 206-10 extend in the direction D2.

The conductive layer 202-1 overlaps the conductive layers 206-1, 206-2, and 206-11. The conductive layer 202-1 is connected to the conductive layer 206-1 via an opening 213-1 arranged in the gate insulating film 203, and is connected to the conductive layer 206-2 via an opening 213-2 arranged in the gate insulating film 203. An area in the conductive layer 202-1, which extends in the direction D1, functions as a scanning signal line wiring. In addition, and area in the conductive layer 202-1, which extends in the direction D2, functions as a gate electrode.

The conductive layers 202-2 and 202-3 overlap the conductive layer 206-4. The conductive layer 202-2 is connected to the conductive layer 206-4 via an opening 213-3 arranged in the gate insulating film 203, and the conductive layer 202-3 is connected to the conductive layer 206-4 via an opening 213-4 arranged in the gate insulating film 203. The conductive layer 206-4 intersects the conductive layer 202-1. The conductive layer 206-4 functions as a first video signal line SL1. In addition, in the conductive layer 206-4, an area that does not overlap the conductive layers 202-2 and 202-3 functions as a source electrode of the transistor Tr. The conductive layer 206-3 functions as a drain electrode of the transistor Tr.

The conductive layer 202-4 overlaps a conductive layer 206-5 and is connected to the conductive layer 206-5 via an opening 213-5 arranged in the gate insulating film 203. The conductive layer 202-5 overlaps a conductive layer 206-6 and is connected to the conductive layer 206-6 via an opening 213-6 arranged in the gate insulating film 203. The conductive layer 206-5 is connected to the conductive layer 206-6 via a conductive layer 208-2. As a result, the conductive layer 206-5, the conductive layer 206-6, and the conductive layer 208-2 function as the third video signal line SL3.

The conductive layer 202-6 overlaps the conductive layer 206-7 and is connected to the conductive layer 206-7 via an opening 213-7 arranged in the gate insulating film 203. The conductive layer 202-7 overlaps the conductive layer 206-8 and is connected to the conductive layer 206-8 via an opening 213-8 arranged in the gate insulating film 203. The conductive layer 206-7 is connected to the conductive layer 206-8 via a conductive layer 208-3. The conductive layer 206-7, the conductive layer 206-8, and the conductive layer 208-3 function as the second video signal line SL2.

The conductive layer 202-8 overlaps the conductive layer 206-9 and is connected to the conductive layer 206-9 via an opening 213-9 arranged in the gate insulating film 203. The conductive layer 202-9 overlaps the conductive layer 206-9 and the conductive layer 206-10. The conductive layer 202-9 is connected to the conductive layer 206-9 via an opening 213-10 arranged in the gate insulating film 203. The conductive layer 202-9 is connected to the conductive layer 206-10 via an opening 213-11 arranged in the gate insulating film 203. The conductive layer 206-9 has an area that intersects the conductive layer 202-1. The conductive layer 206-9 and the conductive layer 206-10 function as the fourth video signal line SL4.

In addition, the conductive layer 202-1 overlaps the conductive layer 206-11 and is connected to the conductive layer 206-11 via an opening 213-12 arranged in the gate insulating film 203.

The conductive layer 202-9 and the conductive layer 206-8 have a bent area. The conductive layer 202-9 has an area that overlaps and intersects the conductive layer 206-8. That is, there is an area where the second source wiring SL2 and the fourth source wiring SL4 intersect.

Although not shown, the conductive layer 202-2 and the conductive layer 206-5 have a bent area. The conductive layer 202-2 has an area that overlaps and intersects the conductive layer 206-5. That is, the first video signal line SL1 has an area that intersects the third video signal line SL3.

As shown in FIG. 6, the scanning signal line GL is formed by stacking the conductive layer 202-1 and the conductive layers 206-1 and 206-2. In addition, in the scanning signal line GL, only the conductive layer 202-1 is arranged in the area that intersects the video signal line SL1 to the video signal line SL4, and the conductive layer 206-1 and the conductive layer 206-2 are separately arranged. In addition, the video signal line SL1 is formed by stacking the conductive layers 202-2 and 202-3 and the conductive layer 206-4. In addition, in the video signal line SL1, only the conductive layer 206-4 is arranged in the area that intersects the scanning signal line GL, and the conductive layer 202-2 and the conductive layer 202-3 are separately arranged.

Next, a cross-sectional structure of the transistor Tr will be described. As shown in FIG. 7, the transistor Tr has a conductive layer 202-1 provided on the array substrate 150, the oxide semiconductor layer 204-1 provided opposite the conductive layer 202-1, a gate insulating film 203 provided between the conductive layer 202-1 and the oxide semiconductor layer 204-1, a conductive layer 206-3 and a conductive layer 206-4 disposed on the oxide semiconductor layer 204-1.

An insulating film 205 is arranged on the transistor Tr. In addition, on the insulating film 205, a conductive layer 208-1 is arranged at a position opposite the oxide semiconductor layer 204-1. The conductive layer 208-1 functions as a back gate electrode. In the present embodiment, the transistor Tr is described as a bottom-gate drive transistor, but the present invention is not limited to this, and may be a top-gate drive transistor or a dual-gate drive transistor.

A planarization film 207 is arranged on the conductive layer 208-1 and an insulating layer 105. The planarization film 207 is arranged to release unevenness of various wirings constituting the transistor Tr. In FIGS. 5 and 7, the area where the planarization film 207 is provided is shown as the wiring area. In the case where the display device 10 is applied to a transparent display, the planarization film 207 is preferably removed at an opening area OP of the pixel PIX. This makes it possible to suppress the planarization film 207 from absorbing light in the opening area OP.

A transparent conductive layer 212 is arranged above the planarization film 207 and the insulating film 205. A conductive layer 214 is arranged above the transparent conductive layer 212. The transparent conductive layer 212 and the conductive layer 214 function as the capacitance wiring. An insulating film 209 is arranged above the transparent conductive layer 212 and the conductive layer 214. A pixel electrode 216-1 is arranged above the insulating film 209. The pixel electrode 216-1 is connected to the conductive layer 206-3 via the openings arranged in the insulating films 205 and 209.

The counter substrate 152 is arranged to face the array substrate 150. A light-shielding layer 219 and the common electrode 218 (also called the counter electrode) are arranged in the counter substrate 152. The light-shielding layer 219 functions as a black matrix. In a configuration shown in FIG. 6, the light-shielding layer 219 is arranged in an area overlapping the conductive layer 206-4 in FIG. 7. The light-shielding layer 219 is arranged in a lattice pattern so as to cover the scanning signal line GL and the video signal line SL1 to the video signal line SL4. The common electrode 218 has a size extending over the entire surface of a display area 112. The light-shielding layer 219 may be formed of a metal film and functions as an auxiliary electrode by being arranged in contact with the common electrode 218 formed of a transparent conductive film. The liquid crystal layer 210 is arranged between the array substrate 150 and the counter substrate 152, and sealed with a sealing material 154 (see FIG. 1). The pixel electrode 216-1, the liquid crystal layer 210, and the common electrode 218 constitute the liquid crystal element LE.

### [Configuration of Dummy Pixel]

Referring again to FIG. 5, the configuration of the dummy pixel DPIX included in the display device 10 according to an embodiment of the present invention will be described.

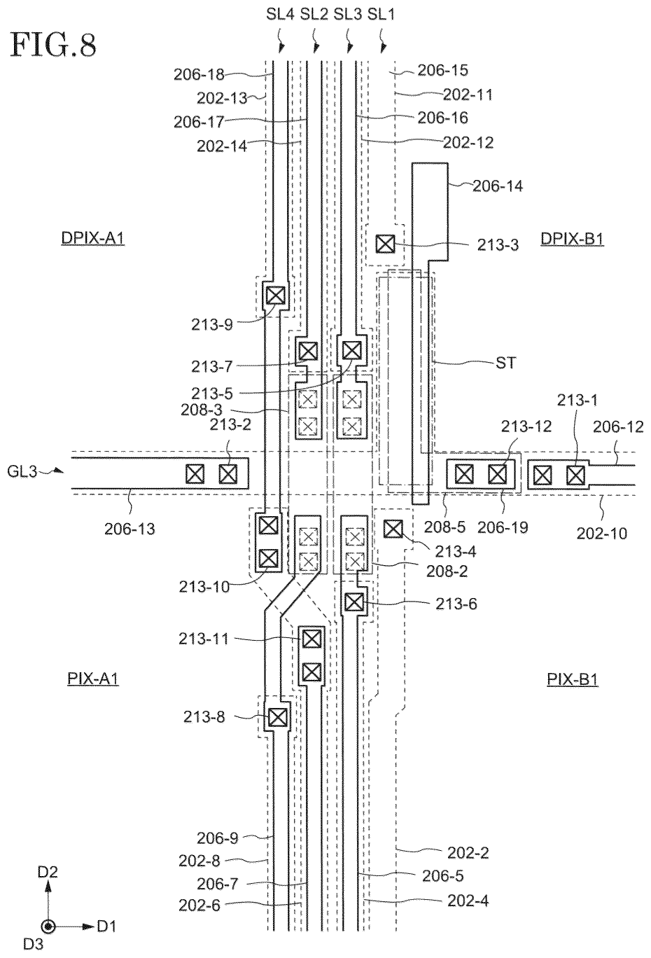

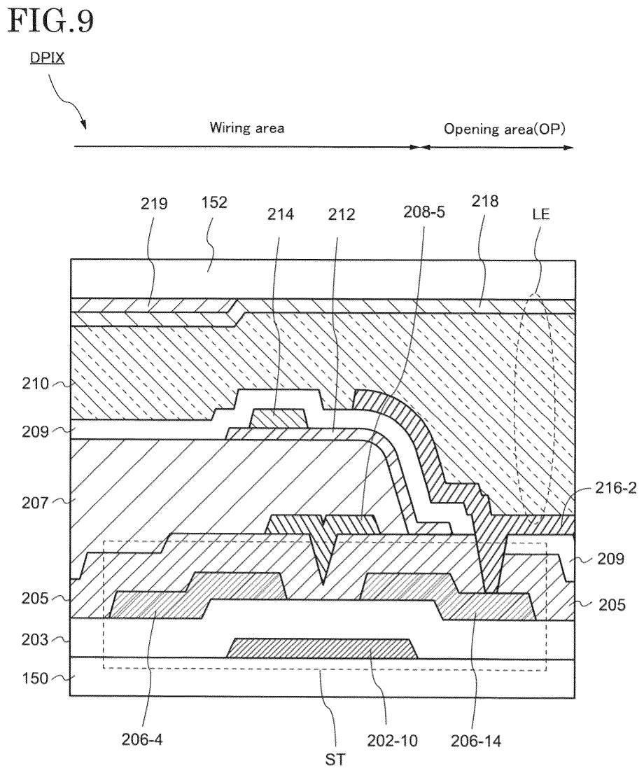

The dummy pixel DPIX has the same area as the pixel PIX and the same shape, but does not have the same structure. The dummy pixel DPIX has a structure ST that does not have a structure as the transistor Tr in the array substrate 150. The structure ST does not have an oxide semiconductor layer 204, which is part of the transistor Tr structure, as shown in FIGS. 8 and 9, for example. The structure ST is not limited to not having an oxide semiconductor layer 204. Furthermore, the configuration of the transistor Tr that is not included in the structure ST is not limited to the oxide semiconductor layer 204. However, the oxide semiconductor layer 204 is preferable because it has a smaller pixel area and higher transmittance than other configurations and therefore has less effect on the transmittance of the dummy pixel DPIX.

Next, the configuration of the structure ST will be described with reference to FIGS. 8 and 9. FIG. 8 is a plan view illustrating the structure ST of the dummy pixel DPX included in the display device according to an embodiment in the present invention. FIG. 9 is a cross-sectional view illustrating the structure ST of the dummy pixel DPIX included in the display device according to an embodiment of the present invention. Note that, with regard to the configuration of the structure ST, descriptions of configurations that are the same as or similar to those of the transistor Tr may be omitted.

The structure ST lacks at least one of the components included in the transistor Tr. The structure ST may have any configuration as long as a voltage corresponding to a video signal is not applied to the pixel electrode 216-1 that constitutes the liquid crystal element LE. The structure ST may be configured to lack at least one of the oxide semiconductor layers 204-1 to 204-5, the conductive layer 206-3, the conductive layer 206-4, and the conductive layer 202-1. The structure ST is preferably free of oxide semiconductor layers 204-1 to 204-5, as shown in FIGS. 8 and 9. Since the structure ST does not include an oxide semiconductor layer with low absorbance, a voltage corresponding to the image signal is not applied to the pixel electrode 216-1, and furthermore, the light transmittance of the dummy pixel DPIX and the pixel PIX can be made to be the same.

### [Materials of Each Member of Display Device 10]

A rigid substrate having light translucency and not flexibility such as a glass substrate, a quartz substrate, and a sapphire substrate can be used as the array substrate 150 and the counter substrate 152. On the other hand, in the case where the array substrate 150 and the counter substrate 152 need to have flexibility, a flexible substrate containing a resin and having flexibility such as a polyimide substrate, an acryl substrate, a siloxane substrate, or a fluororesin substrate can be used as the array substrate 150 and the counter substrate 152. In order to improve the heat resistance of the array substrate 150 and the counter substrate 152, impurities may be introduced into the resin. In addition, in the case where the display device 10 is applied to a transparent display or a large high-definition display, it is preferable to use a glass substrate as the array substrate 150 and the counter substrate 152. In addition, the first transparent substrate 151A and the second transparent substrate 151B are arranged to protect the array substrate 150 and the counter substrate 152. Therefore, for example, it is preferable to use a glass substrate having light transmittance, a plastic substrate, or the like.

A general metal material can be used as the conductive layer 202, the conductive layer 206, the conductive layer 208, and the conductive layer 214. For example, aluminum (Al), titanium (Ti), chromium (Cr), cobalt (Co), nickel (Ni), molybdenum (Mo), hafnium (Hf), tantalum (Ta), tungsten (W), bismuth (Bi), silver (Ag), and alloys or compounds thereof are used as these members. The material described above may be used in a single layer or in a stacked layer as the member described above. For example, stacked layers of Al\Ti are used as the conductive layers 202. For example, stacked layers of TiN\Ti\Al\Ti\TiN are used as the conductive layer 206. For example, Mo is used as the conductive layer 208. A laminated structure of Mo\Al is used as a conductive layer.

Common insulating materials can be used as the gate insulating film 203, the insulating film 205, and the insulating film 209. For example, an inorganic insulating layer such as silicon oxide (SiOₓ), silicon oxynitride (SiOₓN_{y}), silicon nitride (SiNₓ), silicon nitride oxide (SiNₓO_{y}), aluminum oxide (AlOₓ), aluminum oxynitride (AlOₓN_{y}), aluminum nitride oxide (AlNₓO_{y}), and aluminum nitride (AlNₓ) can be used as the gate insulating film 203, the insulating film 205, and the insulating film 209. An insulating layer with few defects can be used as these insulating layers. An organic insulating material such as a polyimide resin, an acryl resin, an epoxy resin, a silicone resin, a fluororesin, or a siloxane resin can be used as the planarization film 207. In addition, the organic insulating materials described above may be used as the gate insulating film 203, the insulating film 205, and the insulating film 209. The above-described material may be used in a single layer or in a stacked layer as the members described above. For example, a stacked structure of silicon nitride and silicon oxide is used as the gate insulating film 203. For example, a stacked structure of silicon oxide and silicon nitride is used as the insulating film 205. In addition, silicon nitride is used as the insulating film 209.

SiOₓN_{y} and AlOₓN_{y} are silicon compounds and aluminum compounds containing nitrogen (N) in a ratio (x>y) smaller than that of oxygen (O). In addition, SiNₓO_{y} and AlNₓO_{y} are silicon compounds and aluminum compounds containing oxygen in a ratio (x>y) smaller than that of nitrogen.

A metal oxide having semiconducting properties can be used as the oxide semiconductor layer 204. The oxide semiconductor layer 204 has light transmittance. For example, an oxide semiconductor containing indium (In), gallium (Ga), zinc (Zn), and oxygen (O) can be used. In particular, an oxide semiconductor having a composition ratio of In:Ga:Zn:O=1:1:1:4 can be used. However, the oxide semiconductor containing In, Ga, Zn and O used in the present embodiment is not limited to the above-described composition, and an oxide semiconductor having a composition other than the above can also be used. For example, the ratio of In may be larger than the above ratio in order to improve mobility. In addition, the ratio of Ga may be larger than the above ratio in order to increase a bandgap and reduce the influence of light irradiation.

In the present embodiment, although an example in which an oxide semiconductor layer is used as the semiconductor layer has been described, a semiconductor layer using amorphous silicon or polysilicon may be used.

A mixture of indium oxide and tin oxide (ITO) and a mixture of indium oxide and zinc oxide (IZO) can be used as the transparent conductive layer 212, the pixel electrode 216, and the common electrode 218. Materials other than the above may be used as the transparent conductive layer. The light-shielding layer 219 used in a black matrix BM may be formed of a black plastic or metal material. The black matrix BM is formed in contact with the common electrode 218 (see FIG. 6). Forming the black matrix BM with the metal material with respect to the common electrode 218 formed from a transparent conductive film makes it possible to have a function as an auxiliary electrode for reducing resistance loss. A material having a relatively low reflectance to aluminum such as chrome, molybdenum, and titanium is preferably used as the metal material forming the black matrix BM.

A polymer-dispersed liquid crystal is preferably used as the liquid crystal layer 210 in the case where the display device 10 is applied to a transparent display. The polymer-dispersed liquid crystal includes bulk and fine particles. An orientation of the fine particles changes in accordance with the potential difference between the pixel electrode 216 and the common electrode 218 in the bulk. A degree of at least one of the translucency or dispersion of light is controlled for each pixel PIX by individually controlling the potential of the pixel electrode 216 for each pixel PIX. A scattering degree of the liquid crystal layer (fine particles) is controlled in accordance with the voltage of each pixel electrode 216 and the voltage of the common electrode 218. For example, the liquid crystal layer may be a polymer-dispersed liquid crystal in which a degree of scattering increases as the voltage between each pixel PIX and the common electrode 218 increases, or a polymer-dispersed liquid crystal in which a degree of scattering increases as the voltage between each pixel electrode 216 and the voltage between the common electrode 218 decreases.

The ordinary refractive indices of the bulk and fine particles are equal to each other in the liquid crystal layer 210. In the state where no voltage is applied between the pixel electrode 216 and the common electrode 218, the refractive index difference between the bulk and the fine particles is zero in all directions. The liquid crystal layer 210 becomes a non-scattering state in which the light emitted from the light source is not scattered. The light emitted from the light source propagates in a direction away from a light source 104 (light-emitting part) while being reflected at a first main surface of the array substrate 150 and a first main surface of the counter substrate 152. In the case where the liquid crystal layer 210 is in the non-scattering state in which the light L emitted from the light source is not scattered, a background of the counter substrate 152 can be visually recognized from the array substrate 150 and a background of the array substrate 150 can be visually recognized from the counter substrate 152.

Between the pixel electrode 216 and the common electrode 218 to which the voltage is applied, an optical axis of the fine particles will be tilted due to an electric field generated between the pixel electrode 216 and the common electrode 218. Since an optical axis of the bulk does not change due to the electric field, directions of the optical axis of the bulk and the optical axis of the fine particles are different from each other. In the pixel PIX having the pixel electrode 216 to which the voltage is applied, the light emitted from the light source is scattered. A part of the scattered light emitted from the light source as described above is emitted to the outside from the first main surface of the array substrate 150 or the first main surface of the counter substrate 152 and is observed by the observer.

In the pixel PIX having the pixel electrode 216 to which the voltage is not applied, the background on the first main surface side of the counter substrate 152 can be visually recognized from the first main surface of the array substrate 150 and the background on the first main surface side of the array substrate 150 can be visually recognized from the first main surface of the counter substrate 152. Further, in the case where the video signal is input to the display device 10 of the present embodiment, a voltage is applied to the pixel electrode 216 of the pixel PIX on which an image is displayed, and an image based on the video signal is visually recognized together with the background. As described above, an image is displayed in the display area when the polymer-dispersed liquid crystal is in the scattering state.

As described above, by making the display area 12 and the non-display area 13 of the display device 10 transparent, it is possible to blur the boundary between the display area 12 and the non-display area 13, thereby improving the visual appearance of the display device even when images are displayed. For example, when the display area of a transparent display is made semicircular, it is possible to minimize the difference in transmittance between the display area 12 and the surrounding non-display area 13, thereby eliminating any sense of incongruity in appearance.

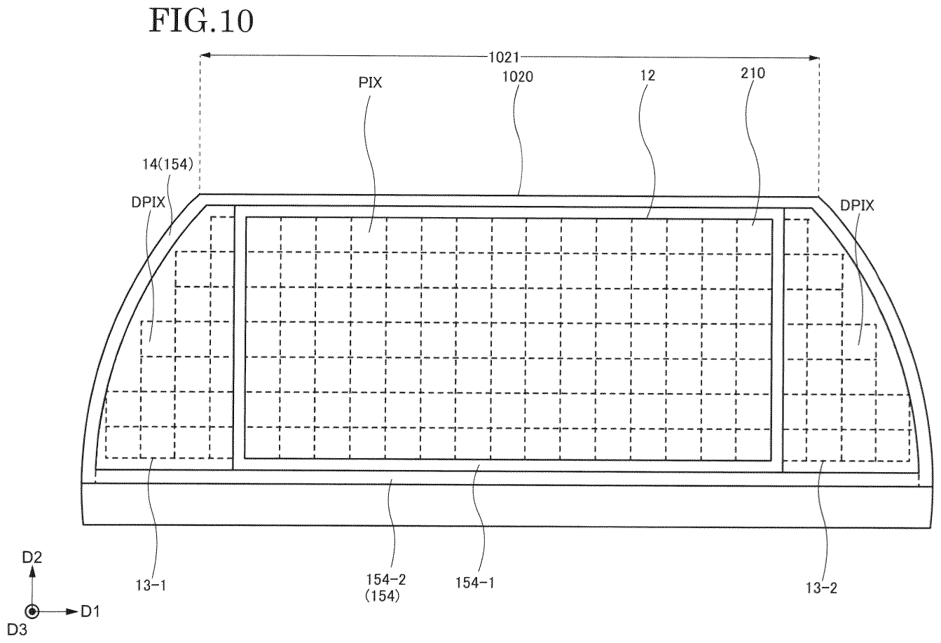

Next, a modification of the display device 10 according to the present embodiment will be described with reference to FIG. 10.

### [Modification]

Referring to FIG. 10, an example of a deformation in the shape of the display panel 102 will be described. FIG. 10 is a plan view of a display device according to an embodiment of the present invention.

The outer peripheral edge 1020 of the display panel 102 may have a straight portion 1021. FIG. 10 shows an example in which the peripheral area 14 and the display area 12 are adjacent to each other by providing the straight portion 1021 on the outer peripheral edge 1020 of the display panel 102, and no non-display area 13 is provided. However, a non-display area 13 may be provided between the peripheral area 14 and the display area 12.

While preferred embodiments have been described above, the present invention is not limited to such embodiments. The contents disclosed in the embodiments are merely examples, and various changes can be made without departing from the spirit of the present invention. Appropriate changes that have been made without departing from the spirit of the present invention naturally fall within the technical scope of the present invention.

What is claimed is:

1. A display device comprising:
a display panel having a liquid crystal layer arranged between a pair of substrates; and
a light source that makes light incident into the liquid crystal layer from one side surface of the display panel;
the display panel includes:
a display area in which a plurality of pixels is arranged; a non-display area adjacent to the display area and in which a plurality of dummy pixels is arranged;
a peripheral area arranged along a periphery of the display panel other than the one side surface and surrounding the non-display area;
a driving circuit arranged in the peripheral area;
a plurality of first wirings connected to the driving circuit and extending in a first direction; and
a plurality of second wirings extending in a second direction intersecting the first direction.
wherein the plurality of pixels and the dummy pixels are the same size and arranged at equal pitch,
the display area and the non-display area are translucent, and
an image displayed in the display area is visible from a first surface of the display panel and from a second surface opposite the first surface.

2. The display device according to claim 1,
wherein the pair of substrates includes an array substrate and a counter substrate facing the array substrate,
the plurality of pixels includes a plurality of pixel electrodes provided on the array substrate and a counter electrode provided on the counter substrate, and
the plurality of dummy pixels includes a plurality of dummy pixel electrodes provided on the array substrate and the counter electrode provided on the counter substrate.

3. The display device according to claim 1,
wherein the driving circuit includes a scanning signal line driving circuit that outputs scanning signals and a video signal line driving circuit that outputs video signals,
the scanning signal line driving circuit and the video signal line driving circuit are arranged in the peripheral area, and
the first wiring extends from the scanning signal line driving circuit and the second wiring extends from the video signal line driving circuit.

4. The display device according to claim 3,
wherein the scanning signal line driving circuit is arranged in the peripheral area in a direction in which the first wiring extends from the display area, and
the video signal line driving circuit is arranged in the peripheral area in a direction in which the second wiring extends from the display area.

5. The display device according to claim 1,
wherein an outer peripheral edge of the display panel has a continuously curved portion.

6. The display device according to claim 5,
wherein the outer peripheral edge of the display panel further includes a straight portion.

7. The display device according to claim 2,
wherein each of the plurality of pixels includes a transistor having an oxide semiconductor layer, a first conductive layer on the oxide semiconductor layer, an insulating film between the oxide semiconductor layer and the first conductive layer, a second conductive layer electrically connected to the oxide semiconductor layer, and a third conductive layer electrically connected to the oxide semiconductor layer, and the pixel electrode electrically connected to the third conductive layer,
each of the plurality of dummy pixels includes a structure lacking at least one of the oxide semiconductor layer, the first conductive layer, the second conductive layer, and the third conductive layer, and includes the pixel electrode, and
the display device further includes a video signal line electrically connected to the second conductive layer.

8. The display device according to claim 1, further comprising,
a first sealing material surrounding the display area,
wherein the first sealing material is arranged to overlap the non-display area.

9. The display device according to claim 1, further comprising,
a second sealing material surrounding the display area and the non-display area.

10. The display device according to claim 1,
wherein the plurality of dummy pixels is arranged in a plurality of columns extending from the display area toward the peripheral area, and
a number of the plurality of dummy pixels in the plurality of columns increases toward the light source.
